(19) United States
(12) Patent Application Publication
(10) Pub. No.: US 2020/0361258 A1
(43) Pub. Date: Nov. 19, 2020

(54) Truck Saver

(71) Applicant: Jose Antonio Roman, JR., Peoria, AZ (US)

(72) Inventor: Jose Antonio Roman, JR., Peoria, AZ (US)

(21) Appl. No.: 16/163,547

(22) Filed: May 15, 2019

(51) Int. Cl. B60D 1/145; B60D 1/06

(52) U.S. Cl. CPC B60D 1/145; B60D 1/06

(57) ABSTRACT

The Truck Saver is a removable apparatus used for attaching a boat trailer to a tow vehicle. Measuring at 13 feet 1 inch The Truck

Saver prevents the tow vehicle from submerging into the water during launching and retrieving a boat. The equipment comprises of 2 metal poles one pole is 6-foot-long and the second is 6 foot 6 inches, at the end is a ball mount. To explain, the ball mount is the attached to the towing vehicle. On the other side of The

Truck Saver remains a 12 inch by 12-inch square platform with two 15-inch wheels and an exchangeable tow ball used to mount a boat trailer. The length of the metal rods extends the distance from the truck and boat trailer allowing the user to submerge the boat while keeping the integrity of the truck pristine and unaffected by the water. Once boat retrieval is accomplished it can be disassembled for transport and storage.

The Truck Saver was created when I had to park a travel trailer at a 90 degree angle with limited space realizing it could be used in the process of launching and retrieving boats. The Truck Saver consists of multiple pieces: 2 square metal poles approximately 6′ long each, a 12′×12′ platform with 2-15″ wheels and an exchangeable towing ball attached to platform. I searched the patent website but came across no prior art that resembled The Truck Saver. I received a catalog from the company that I bought wheels from for The Truck Saver, Northern Tools and Equipment. In it I came across 3 other prior arts that resembled mine but were very limited in size and length and are of an entirely different use. They are made to be towed with all terrain vehicles and can handle a max weight of 1200 Lbs, and are about 4′ in length, without the added benefit of extension so it can be used while launching and retrieving boats.

### CLAIMS

The benefits of using The Truck Saver are the ease of parking trailers at tight angles.

No lights or electronics to be damaged while being submerged under water. Greatly reducing the possibilities of having a vehicle plunge in the water while launching and retrieving boats, thus avoiding an expensive insurance claim.

### OPERATION

To use The Truck Saver, you attach square metal pole 2 to the platform 3. Secure with ⅝th pin 4, finally attach the square metal pole with ball mount 1 to square pole 2 and secure with ⅝th pin 4. The Truck Saver is now ready for use.

### BRIEF DESCRIPTION OF DRAWING

FIG. 1 shows The Truck Saver at an unassembled top angled view.

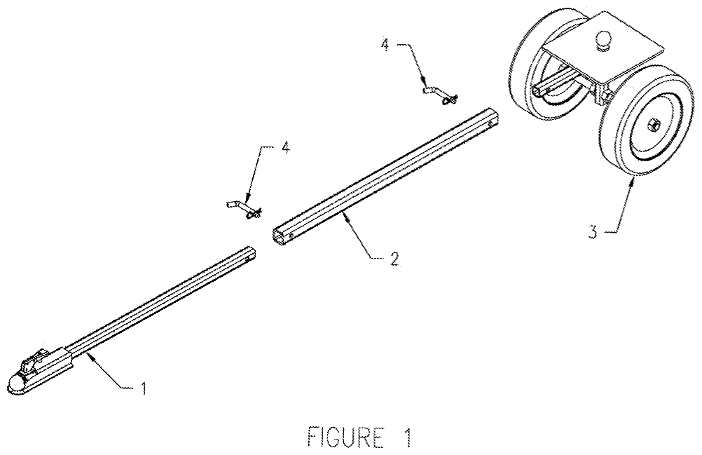

The substitute specification contains no new matter.

1- A removable apparatus used for attaching a boat trailer to tow vehicle to prevent vehicles from plunging in the water while launching and retrieving boats, comprising:
a) 1 square metal tube with holes for a ⅝th pin and a ball mount attached
b) 1 square metal tube with 2 holes for attaching a ⅝th pin
c) A square metal platform with 1,000 lbs capacity with an exchangeable tow ball
d) attach square metal tube 2 with 2 holes to the platform 3 secure with ⅝th pin 4
e) attach the square metal pole with ball mount 1 to square pole on 2 and secure with ⅝th pin 4
f) attach The Truck Saver to tow vehicle, attach boat trailer to tow ball on platform 3
